(19) United States
(12) Patent Application Publication
(10) Pub. No.: US 2009/0304421 A1
(43) Pub. Date: Dec. 10, 2009

(54) IMAGE HEATING APPARATUS

(75) Inventors: Tohru Saito, Mishima-shi (JP); Hiroki Asano, Susono-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/477,403

(22) Filed: Jun. 3, 2009

(30) Foreign Application Priority Data
Jun. 4, 2008 (JP) 2008-147180

(51) Int. Cl. G03G 15/20

(52) U.S. Cl. 399/329

(57) ABSTRACT

A ceramic heater in contact with an inner surface of an endless belt includes a substrate made of alumina and a heat generation resistor provided on the substrate. The heat generation resistor is disposed at a surface reverse to a surface facing the inner surface of the endless belt on the substrate. The substrate is one of a plurality of substrates which are divided from a large substrate along breaks formed on the large substrate, and a surface of the ceramic heater, which is on a side where the breaks are formed, is brought into contact with the inner surface of the endless belt. The holder for holding the ceramic heater has a projection for guiding the endless belt in such a manner that the endless belt cannot be brought into contact with the break of the substrate.

### BACKGROUND OF THE INVENTION

1. Field of the Invention

The present invention relates to an image heating apparatus suitable for use as a fixing device to be provided on an image forming apparatus, such as a copier or a printer, having a function of forming an image onto a recording material such as a sheet.

2. Description of the Related Art

In recent years, energy saving has been earnestly demanded from the viewpoint of an influence on terrestrial environment. There has been known a film fixing device as an image heating apparatus which can warm up in a short time and with saved energy.

A fixing device of a film heating system includes a plate-like heat generator (i.e., a heater), a flexible sleeve (hereinafter referred to as a fixing film or an endless belt), and an elastic roller which forms a nip portion between the plate-like heat generator and the same via a fixing film, and thus, heats an image while holding and feeding a recording material carrying the image on the nip portion. Here, the plate-like heat generator is generally a ceramic heater, and it is securely supported by a supporter. In the meantime, the flexible sleeve is moved in contact with the plate-like heat generator, and is constituted of a heat resistant resin film or a metallic film. In addition, the recording material carrying the image is held and conveyed between the fixing film and the elastic roller on the nip portion.

In the film fixing device such configured as above, the heat capacity of the fixing film is very small, and therefore, the temperature of the nip portion can be increased up to a predetermined fixable value in a short time after power is turned on in the plate-like heat generator.

As the above-described fixing device of the film heating system in the related art has been known a fixing device disclosed in Japanese Patent Application Laid-open (JP-A) Nos. 2000-208239 and 2006-92785. However, the above-described related art induces apprehension of the following problems.

In the film fixing device disclosed in JP-A No. 2000-208239, a fixing film is made of a resin such as polyimide, and a heater is constituted of a substrate made of aluminum nitride. In this conventional heater, a mechanical scribing line is formed on a substrate sheet made of aluminum nitride for taking numerous pieces by a diamond cutter or the like. Slender substrates made of aluminum nitride are taken by cleaving the sheet along the scribing line, and then, a resistant heat generator is formed on a side of a scribing line forming surface.

Since the conventional heater which uses the aluminum nitride substrate as the substrate for the ceramic heater is expensive, there has been apprehension that the film fixing device cannot be provided at a reduced cost.

In contrast, if an alumina substrate of a lower cost is used as the ceramic heater substrate, there has been apprehension that the substrate is weak at heater cracks at the time of an abrupt increase in temperature.

In the case where the scribing line such as a laser scribing line is formed at the same surface as the resistant heat generator forming surface by the use of the alumina substrate, there arises the following apprehension. That is to say, the alumina substrate has a lower heat conductivity than that of the aluminum nitride substrate, and therefore, a thermal stress exerted on the heater is larger than that in the case of the aluminum nitride substrate, thereby causing heater cracks in a short time due to asperities on a scribing line portion, micro cracks, or the like.

On the other hand, in the conventional fixing device exemplified in JP-A No. 2006-92785, a fixing film has a base made of a thin metallic film such as stainless. A heater is constituted of an alumina substrate, and a resistant heat generator is formed at a surface (i.e., a reverse) on which a fixing film cannot slide. A scribing line is formed at a slide surface (i.e., an obverse), and the slide surface and a scribing line ridge are covered with a protecting layer. This is shown in FIG. 7.

Since the scribing line ridge is covered with a protecting layer 19f, the above-described heater is fabricated by utilizing thixotropy by printing the protecting layer at intervals after dividing substrates, and therefore, the number of heater fabricating processes is increased more than usual, thereby raising apprehension of an increase in cost.

The present invention has been accomplished to solve the above-described problems experienced in the related art. Therefore, an object of the present invention is to provide an image heating apparatus capable of achieving a long lifetime at a reduced cost.

### SUMMARY OF THE INVENTION

The present invention has been accomplished to solve the above-described problems experienced in the related art. Therefore, an object of the present invention is to provide an image heating apparatus capable of achieving a long durable lifetime at a reduced cost.

Another object of the present invention is to provide an image heating apparatus for heating a recording material carrying an image thereon, the image heating apparatus including:

an endless belt having a metallic base layer;

a ceramic heater in contact with an inner surface of the endless belt, the ceramic heater including a substrate made of alumina and a heat generation resistor provided on the substrate;

a holder which holds the ceramic heater; and

a pressure roller which forms a nip portion at which the recording material carrying the image thereon is held and conveyed together with the ceramic heater via the endless belt,

wherein the heat generation resistor is disposed at a surface reverse to a surface facing the inner surface of the endless belt on the substrate,

wherein the substrate is one of a plurality of substrates which are divided from a large substrate along breaks formed on the large substrate, and a surface of the ceramic heater, which is on a side where the breaks are formed, is brought into contact with the inner surface of the endless belt, and

wherein the holder has a projection for guiding the endless belt in such a manner that the endless belt cannot be brought into contact with the break of the substrate.

A further object of the present invention is to provide an image heating apparatus for heating a recording material carrying an image thereon, the image heating apparatus including:

an endless belt having a metallic base layer;

a ceramic heater in contact with an inner surface of the endless belt, the ceramic heater including a substrate made of alumina and a heat generation resistor provided on the substrate;

a holder which holds the ceramic heater; and

a pressure roller which forms a nip portion at which the recording material carrying the image thereon is held and conveyed together with the ceramic heater via the endless belt,

wherein the heat generation resistor is disposed at a surface reverse to a surface facing the inner surface of the endless belt on the substrate,

wherein the substrate is one of a plurality of substrates which are divided from a large substrate along breaks formed on the large substrate, and a surface of the ceramic heater, which is on a side where the breaks are formed, is brought into contact with the inner surface of the endless belt, and

wherein the following expression is satisfied:

0.3≦d/W≦0.7

assuming that W (mm) represents a width of the ceramic heater in a recording material conveying direction and d (mm) represents a width of a slide region between the endless belt and the ceramic heater.

A still further object of the present invention will be obvious by reading the detailed description below while referring to the attached drawings.

### BRIEF DESCRIPTION OF THE DRAWINGS

FIG. 1 is a cross-sectional view schematically showing essential parts in the surroundings of a heater in a fixing device in a first embodiment according to the present invention;

FIG. 2 is a cross-sectional view schematically exemplifying an image forming apparatus having an image heating apparatus provided thereon according to the present invention;

FIG. 3 is a cross-sectional view schematically showing the fixing device in the first embodiment according to the present invention;

FIG. 4 is a cross-sectional view schematically showing the heater in the first embodiment according to the present invention;

FIG. 5 is a diagram schematically illustrating ridge asperities (semicircles) of a laser scribing trace remaining on the heater on which a split line is formed by laser scribing;

FIG. 6 is a cross-sectional view schematically showing essential parts in the surroundings of a heater in a fixing device in a second embodiment according to the present invention; and

FIG. 7 is a cross-sectional view schematically showing essential parts in the surroundings of a heater in a fixing device in the related art.

### DESCRIPTION OF THE EMBODIMENTS

Referring to the drawings, a detailed description will be illustratively given below of best modes carrying out the present invention. Here, the dimension, material, shape, and relative arrangement of constituent parts described in the carrying-out modes should be appropriately modified according to the configuration of an apparatus, to which the invention is applied, or various conditions, and therefore, the scope of the present invention should not be limited to the carrying-out modes described below.

### First Embodiment

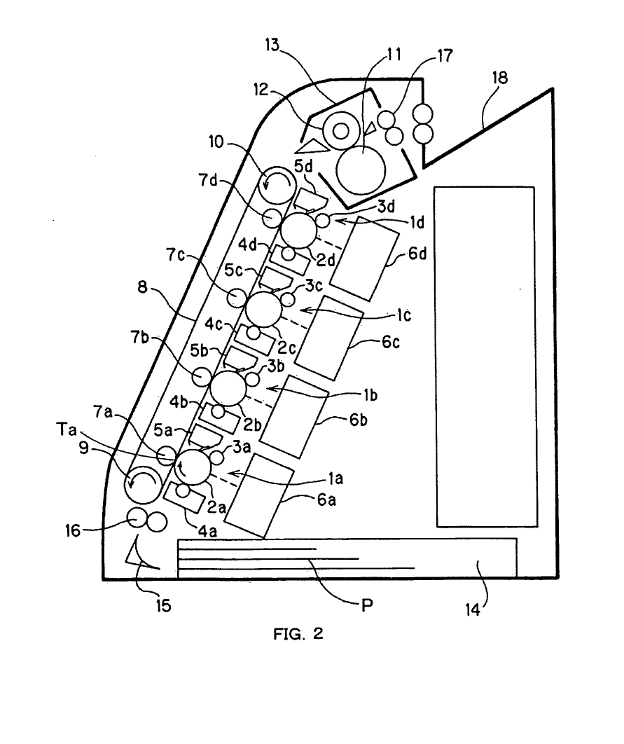

FIG. 2 is a cross-sectional view schematically exemplifying an image forming apparatus having an image heating apparatus provided thereon in a first embodiment according to the present invention. The image forming apparatus in the present embodiment is a laser printer utilizing an electrophotographic image forming process.

The image forming apparatus according to the present invention is provided with four image forming sections (i.e., image forming units or image forming means). The four image forming sections include an image forming section 1a for forming a yellow image, an image forming section 1b for forming a magenta image, an image forming section 1c for forming a cyan image, and an image forming section 1d for forming a black image. These four image forming sections 1a, 1b, 1c, and 1d are aligned at predetermined intervals.

The image forming sections 1a, 1b, 1c, and 1d include electrophotographic photosensitive members (hereinafter referred to as photosensitive drums) 2a, 2b, 2c, and 2d of a drum type serving as image bearing members, respectively. Around the photosensitive drums 2a, 2b, 2c, and 2d, there are arranged chargers 3a, 3b, 3c, and 3d; developing devices 4a, 4b, 4c, and 4d; and drum cleaning devices 5a, 5b, 5c, and 5d, respectively. Each of exposing devices 6a, 6b, 6c, and 6d is disposed above between the charger 3 and the developing device 4. The developing devices 4a, 4b, 4c, and 4d contain therein a yellow toner, a magenta toner, a cyan toner, and a black toner, respectively.

Each of the photosensitive drums 2a, 2b, 2c, and 2d is an OPC photosensitive member charged negatively, and has a photoconductive layer on a drum base member made of aluminum. The photosensitive drum is rotationally driven at a predetermined process speed in a direction indicated by an arrow shown in FIG. 2 (i.e., clockwise) by a drive device, not shown. The chargers 3a, 3b, 3c, and 3d serving as charging means are adapted to uniformly charge the surfaces of the photosensitive drums 2a, 2b, 2c, and 2d to a predetermined potential of a negative polarity by a charging bias to be applied from a charging bias power source, not shown.

The developing devices 4a, 4b, 4c, and 4d allow the toners of colors to adhere to electrostatic latent images formed on the photosensitive drums 2a, 2b, 2c, and 2d, respectively, thereby developing (i.e., visualizing) the electrostatic latent images as toner images (i.e., developer images). A two-component contact developing method may be used as a developing method with each of the developing devices 4a, 4b, 4c, and 4d, in which the toner is carried by magnetic force while using, for example, a mixture of a magnetic carrier and a toner particle as a developer so that the image is developed in contact with each of the photosensitive drums.

Transfer rollers 7a, 7b, 7c, and 7d serving as transfer means are constituted of elastic members. The transfer rollers 7a, 7b, 7c, and 7d abut against the photosensitive drums 2a, 2b, 2c, and 2d at transfer nip portions, respectively, via a recording material conveying belt (hereinafter referred to as a transfer belt) 8 of an endless belt type. Incidentally, the transfer roller 7 is used as the transfer means herein, but may be a transfer blade which receives a high pressure in transferring the toner image onto the recording material and abuts against the transfer belt 8.

The drum cleaning devices 5a, 5b, 5c, and 5d remove and recover residual toners remaining on the photosensitive drums 2a, 2b, 2c, and 2d, respectively.

The exposing devices 6a, 6b, 6c, and 6d output laser beams modulated in response to a time-sequence electric digital pixel signal of image information from laser output units, not shown, to expose the surfaces of the photosensitive drums 2a, 2b, 2c, and 2d via polygon mirrors, not shown, rotated at a high speed, respectively. In this manner, the exposing devices 6a, 6b, 6c, and 6d form electrostatic latent images of colors on the surfaces of the photosensitive drums 2a, 2b, 2c, and 2d charged by the chargers 3a, 3b, 3c, and 3d according to the image information, respectively.

The transfer belt 8 is stretched between a drive roller 9 and a tension roller 10, and is rotated (i.e., moved) in a direction indicated by another arrow shown in FIG. 2 (i.e., counterclockwise) by the drive of the drive roller 9. The transfer belt 8 is made of a dielectric resin such as a polycarbonate resin film, a polyethylene terephthalate resin film, or a polyvinylidene fluoride resin film.

Moreover, a fixing device 13 including a fixing film 11 serving as a flexible sleeve (i.e., a flexible member) containing a heater (i.e., a heating source) 19 therein and a pressure roller 12 serving as a drive member is disposed downstream of the transfer belt 8 in the recording material conveying direction.

Next, explanation will be made below on an image forming operation by the image forming apparatus in the present embodiment.

Upon issuing an image formation starting signal, the photosensitive drums 2a, 2b, 2c, and 2d in the image forming sections 1a, 1b, 1c, and 1d to be rotationally driven at a predetermined process speed are uniformly charged to the negative polarity by the chargers 3a, 3b, 3c, and 3d, respectively. In the exposing devices 6a, 6b, 6c, and 6d, laser output units, not shown, convert image signals of output images into optical signals, respectively. The laser beams which is the converted optical signals scan and expose the surfaces of the photosensitive drums 2a, 2b, 2c, and 2d, thereby forming the electrostatic latent images.

First, the yellow toner is allowed to adhere onto the electrostatic latent image formed on the photosensitive drum 2a by the developing device 4a, to which a development bias of the same polarity as the charging polarity (i.e., the negative polarity) of the photosensitive drum 2a is applied, thereby visualizing the latent image as a toner image.

At a timing at which the tip of the toner image on the photosensitive drum 2a is moved to the transfer portion between the photosensitive drum 2a and the transfer roller 7a, a recording material P to be fed from a feed cassette 14 through a recording material feeding guide 15 is fed to the transfer portion by resist rollers 16. The yellow toner image is transferred onto the recording material P fed to the transfer portion by the transfer roller 7a, to which the transfer bias having a polarity reverse to that of the toner (i.e., a positive polarity) is applied.

The recording material P, onto which the yellow toner image is transferred, is moved to the image forming section 1b by the recording material conveying belt 8. Also in the transfer portion constituted of the photosensitive drum 2b and the transfer roller 7b, the magenta toner image formed on the photosensitive drum 2b is transferred onto the yellow toner image formed on the recording material P in superimposition, like in the transfer portion constituted of the photosensitive drum 2a and the transfer roller 7a.

In the same manner, the cyan and black toner images formed by the photosensitive drums 2c and 2d in the image forming sections 1c and 1d, respectively, are transferred in superimposition on the yellow and magenta toner images transferred in superimposition on the recording material P, thereby forming a full-color toner image on the recording material P.

The recording material P having the full-color toner image formed thereon is conveyed to the fixing device 13. In the fixing device 13, a nip portion (i.e., a fixing nip portion) is formed between the heater 19 in the fixing film 11 and the pressure roller 12. The recording material is held and conveyed between the fixing film 11 and the pressure roller 12 on the fixing nip portion, whereby the full-color toner image is heated and pressurized to be thermally fixed onto the recording material P. Thereafter, the recording material P having the full-color toner image fixed thereto is discharged onto a discharge tray 18 by discharge rollers 17, thus completing a series of image forming operations.

In transferring the above-described image to the recording material from the photosensitive drum, residual toners remaining on the photosensitive drums 2a, 2b, 2c, and 2d are removed and recovered by the drum cleaning devices 5a, 5b, 5c, and 5d, respectively.

At the time of a monochromatic image output, the above-described image forming processes are performed only in the image forming section 1d for forming the black image.

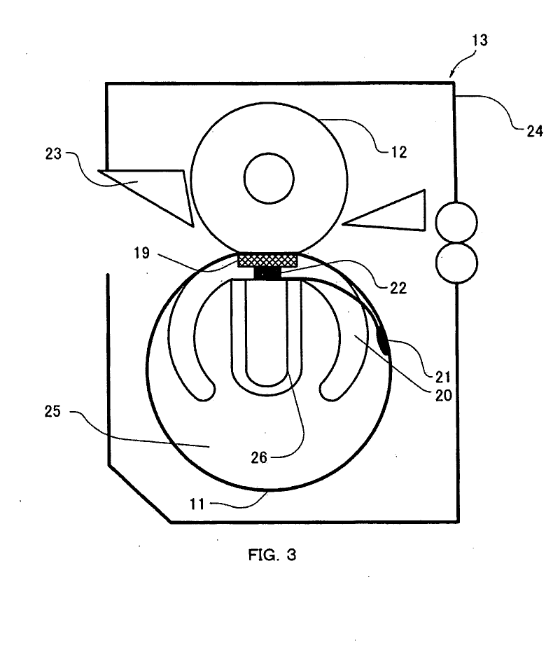

Subsequently, the fixing device (i.e., the image heating apparatus) in the present embodiment will be described with reference to FIG. 3.

FIG. 3 is a cross-sectional view schematically showing the fixing device 13 in the present embodiment.

The fixing device in the present embodiment is constituted of the heater (i.e., the ceramic heater) 19, a heater holder 20, a main thermistor 21, a sub thermistor 22, the fixing film (i.e., an endless belt) 11, the pressure roller 12, and an inlet guide 23.

The heater holder 20 is made of a crystal polymer resin having a high heat resistance. The heater holder 20 holds the heater 19 and the fixing film 11, and further, guides the fixing film 11.

In the present embodiment, E4205L B manufactured by Sumitomo Chemical Co., Ltd. is used as a crystal polymer for the material of the heater holder. A maximum usable temperature (i.e., a load flexure temperature) of the crystal polymer is about 305° C.

The main thermistor 21 is adapted to detect the temperature of the inner surface of the fixing film 11, and is provided for controlling the temperature of the fixing device 13.

The main thermistor 21 has a thermistor element at the tip of an arm made of stainless (SUS). The thermistor element can be kept all the time in contact with the inner surface of the fixing film 11 even in an unstable state of the movement of the inner surface of the fixing film 11 due to the oscillation of the arm.

The main thermistor 21 is connected to a CPU, not shown, serving as control means. The CPU determines the contents of a temperature control of the heater 19 in response to an output from the main thermistor 21, thereby controlling energization to the heater 19.

The sub thermistor 22 is attached to the reverse of the heater 19. When the heater 19 is excessively increased in temperature for some reason, the sub thermistor 22 fulfills the function of performing a limiter control. In the present embodiment, the sub thermistor 22 is arranged at the longitudinal end of the heater 19, and detects an increase in temperature at the end of the fixing device 13 when the recording material of a small size passes. Here, the longitudinal direction signifies a direction perpendicular to the recording material conveying direction, that is, the axial direction of the pressure roller 12, or the longitudinal direction of the fixing nip portion defined between the fixing film 11 and the pressure roller 12. When it is determined based on the detection result of the sub thermistor 22 that the end of the fixing device 13 is increased in temperature, the CPU controls to decrease the fixing temperature to prevent any excessive increase in temperature of the fixing device.

The pressure roller 12 is made by forming a conductive silicone rubber layer having a thickness of about 2 mm on a core metal, and covering the layer with a conductive PFA resin tube having a thickness of about 50 μm A longitudinal size of the pressure roller 12 is set to about 330 mm in such a manner as to handle a recording material of an SRA3 size. Here, PFA abbreviates a tetrafluoroethylene-perfluoroalkylvinyl ether copolymer.

The inlet guide 23 fulfills the function of accurately guiding the recording material P passing through a secondary transfer nip portion to the fixing nip portion.

The pressure roller 12 and the inlet guide 23 are incorporated in a frame 24.

Under the pressure roller 12 and the inlet guide 23 is placed a fixing film unit 25 incorporating therein the heater 19 disposed in the heater holder 20, the main thermistor 21, and the sub thermistor 22. The fixing film unit 25 is pressurized by a force of about 30 kgf (294 N) (about 15 kgf on either side) by a pressurizing mechanism, not shown, via a T stay 26 disposed along the heater holder 20.

In the fixing device in the present embodiment, when the fixing film 11 is driven by the rotation of the pressure roller 12, the fixing film 11 is driven to be rotated. At this time, the inner surface of the fixing film 11 and the heater 19 slide each other (that is, the fixing film 11 is moved in contact with the heater 19), and further, the inner surface of the fixing film 11 and the heater holder 20 slide each other. Grease is applied to the inner surface of the fixing film 11, thereby securing the slidability between the heater holder 20 and the inner surface of the fixing film 11.

During normal use, upon start of the rotation of the fixing device, the fixing film 11 is started to be rotationally driven. With the increase in temperature of the heater 19, the temperature at the inner surface of the fixing film 11 also is increased. Accordingly, the surface temperature of the fixing film 11 also is increased.

The fixing film 11 serving as the fixing member uses a stainless (exemplified by SUS304 in the present embodiment) film formed into an endless belt having a thickness of about 30 μm as a base layer. The silicone rubber layer as an elastic layer is formed on the base layer, and further, is covered with a PFA resin tube having a thickness of about 20 μm as a separation layer.

In order to decrease a difference in temperature at the inner and outer surfaces of the fixing film 11, as possible, it is preferable that the thickness of the silicone rubber layer as the elastic layer should be thin. In addition, a material having a high thermal conductivity should be preferably used for rubber.

In order to enhance the thermal conductivity, the amount of fillers contained in the rubber layer has been usually increased in the related art. However, a mere increase in amount of fillers induces various inconveniences.

The increase in amount of fillers can enhance the thermal conductivity. However, the increase in amount of fillers of alumina or the like higher in specific gravity than the silicone rubber polymer increases a specific gravity of the rubber layer per se. This increases a thermal capacity of the rubber layer, with a disadvantage from the viewpoint of a temperature rising-up time of the fixing member. The mere increase in amount of fillers induces an increase in hardness of the rubber layer or degradation of permanent deformation of the rubber. It is desirable that the thermal conductivity of the rubber layer should be about 1 W/mK or more. In the present embodiment, the rubber layer having a thermal conductivity of about 1.3 W/mK is used.

The thickness of the silicone rubber layer of the fixing film 11 should be desirably increased, as possible, from the viewpoint of a quality of an image having, for example, a transmitting property of OHT (overhead transparency), or having, for example, no minute lustrous variation on the image. Resulting from a study by the inventors of the present application, it is found that a thickness of 200 μm or more is needed to obtain a quality of an image on a satisfying level.

In contrast, if the thickness of the rubber layer is increased more than necessary, the fixing member per se is increased in thermal capacity, with the disadvantage from the viewpoint of the temperature rising-up time of the fixing member. Accordingly, the silicone rubber layer in the present embodiment has a thickness of about 200 μm to 300 μm.

From the viewpoint of the temperature rising-up time of the fixing member, the fixing film 11 as the fixing member per se should be desirably decreased in thermal capacity.

In order to decrease the thermal capacity of the fixing film per se, the diameter of the fixing film is conceived to be decreased. However, if the diameter of the fixing film is decreased more than necessary, the ceramic heater which is housed inside as the heating source cannot be disposed from the viewpoint of a space or a nip portion width required for fixing performance cannot be secured, thereby justly raising a limit.

In view of the above, the inner diameter of the fixing film 11 in the embodiment is about 24 mm.

The longitudinal size of the fixing film 11 is about 340 mm in order to handle the recording material of an SRA3 size (having a sheet width of 320 mm) as A3 plus.

Additionally, a fluorine resin layer is formed on the fixing film 11, thereby enhancing separation performance of the surface, so as to prevent any offset phenomenon generated when the toner adheres onto the fixing film 11 once, and then, is moved again to the recording material P.

The separation layer on the fixing film 11 is made of the PFA tube, and therefore, the uniform separation layer can be readily formed. In the present embodiment, the PFA tube having a thickness of about 20 μm to 30 μm is used.

The heater 19 as the heating source is a so-called ceramic heater.

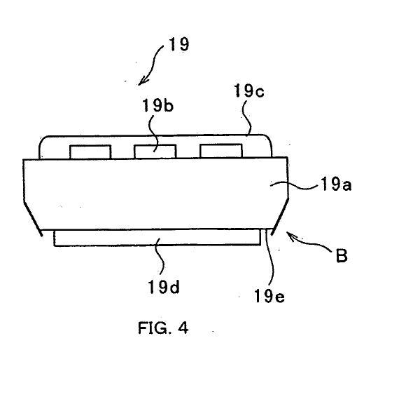

FIG. 4 is a cross-sectional view schematically showing the heater 19 in the present embodiment.

The heater 19 in the present embodiment is a heater shown in FIG. 4 as one example of the ceramic heater. This heater includes a ceramic substrate 19a (i.e., on a substrate made of ceramic) and a heat generator 19b as a resistance heat generator for generating heat by energization, which is formed on a ceramic substrate 19a by screen-printing heat generating paste made of AgPd (a silver-palladium alloy) whose resistance is adjusted. The ceramic substrate 19a is made of alumina. In the present embodiment is used alumina (Al₂O₃) in which a longitudinal length (i.e., a width) is about 380 mm, a length in the recording material conveying direction is about 8 mm, and a thickness is about 1 mm. Moreover, the heat generator 19b is covered with a glass protecting film (i.e., a surface protecting layer) 19c for the purpose of protection. A slide layer 19d, which slides on the fixing film 11, is formed at a surface reverse to the surface, at which the heat generator 19b is disposed, and facing the fixing film 11 on the ceramic substrate 19a.

The heater 19 in the present embodiment includes three heat generators 19b. Heat generation distributions in the longitudinal direction are different between the center heat generator and the side heat generators.

The heater 19 is controlled to be driven by appropriately varying the ratio of energization to the center heat generator (hereinafter referred to as a sub heat generator) to energization to the side heat generators (hereinafter referred to as main heat generators) according to the size of the recording material. Thus, the heat generation distributions in the longitudinal direction are optimized according to the size of the recording material.

Here, after the plurality of heaters are formed by using the ceramic substrate having the size corresponding to the number of heaters, the ceramic substrate is cut along a split line (i.e., a break) formed on the ceramic substrate into the heaters 19. That is to say, laser scribing as the split line is applied to the alumina substrate (a large substrate) for taking numerous pieces (that is, the split line is formed by the laser scribing), and then, the substrate is split along a laser scribing line (i.e., the split line), thereby taking the individual heaters 19.

In the present embodiment, the laser scribing line is formed on the side of the slide layer 19d at a surface reverse to the surface at which the heat generators 19b are disposed. This status is shown in FIG. 4.

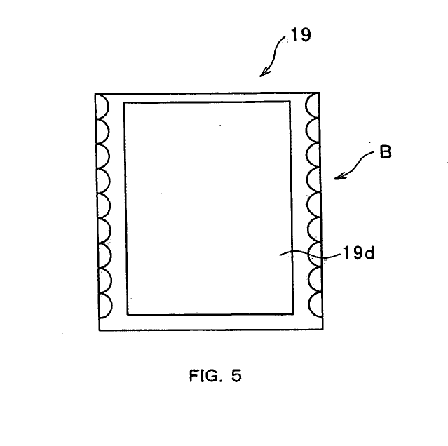

FIG. 5 is a diagram schematically illustrating ridge asperities (semicircles) of a laser scribing trace B remaining on the heater 19 on which the split line is formed by the laser scribing.

When the split line is formed by the laser scribing, the ridge asperities (the semicircles), micro cracks, or the like of the laser scribing trace B remain, as shown in FIG. 5.

A time until the heater cracks at the time of runaway is compared between the case of the related art in which the laser scribing trace is formed on the side of the heat generator 19b and the case of the present embodiment in which the laser scribing trace is formed on the side reverse to the side of the heat generator 19b (i.e., the side of the slide layer which slides on the fixing film). The comparison result is shown in Table 1 below. Table 1 shows a time from a room temperature state until the heater cracks when about 1900 W equivalent to the runaway is turned into the fixing device. In other words, a maximum output of the heater is 1900 W in the fixing device in the present embodiment.

TABLE 1

| | | TIME UNTIL |
|---|---|---|
| | | HEATER CRACKS |
| | | AT TIME OF |
| | | TURNING ABOUT |
| | LASER SCRIBING | 1900 W |
| RELATED ART | SAME SURFACE AS | 1.7 SEC. TO 2.3 SEC. |
| | RESISTANT HEAT | |
| | GENERATOR | |
| PRESENT | SURFACE REVERSE TO | 3.0 SEC. TO 3.6 SEC. |
| EMBODIMENT | SURFACE OF RESISTANT | |
| | HEAT GENERATOR | |
| | (SIDE OF SLIDE SURFACE | |
| | ON FIXING FILM) | |

In the case where the laser scribing surface is formed at the same surface as the resistant heat generator and the asperities, micro cracks, or the like remain at the ridge of the split line, like in the related art, a large power is turned into the heater, thereby generating warpage or a thermal stress on the ceramic substrate due to thermal expansion on the side of the surface of the resistant heat generator. As a consequence, when the asperities, micro cracks, or the like are formed on the side of the thermal expansion, the heater is liable to crack, and therefore, the heater cracks in as short a time as about 1.7 sec. to 2.3 sec. This phenomenon is conspicuous, in particular, when the ceramic heater having a maximum output of 1000 W or higher is used.

When the heater cracks in a short time, the heater cracks earlier than when a safety circuit is operated to stop the energization to the heater. Incidentally, the safety circuit is exemplified by a circuit which detects a heater temperature by a thermistor in contact with the heater and detects an abnormal high temperature at the time of the runaway to stop the energization to the heater.

In contrast, when the surface reverse to the surface at which the resistant heat generator is formed is subjected to the laser scribing, like in the present embodiment, the asperities, micro cracks, or the like due to the laser scribing are not formed on the side of the thermal expansion, and therefore, the heater cracks in about 3 sec. to 3.6 sec. which is later than in the related art. As a consequence, a sufficient margin time (about 1 sec. in the present embodiment) can be secured before the heater cracks at the time of the runaway, and the safety circuit can stop the energization to the heater, thereby preventing the heater from cracking at the time of the runaway.

In the vicinity of a laser scribing hole, there occurs deformation or a raised portion of the substrate at the time of the laser scribing, or a burr at the time of cracking. As a consequence, when such a portion occurs at the slide surface on the fixing film, there arises a drawback of the slide on the fixing film.

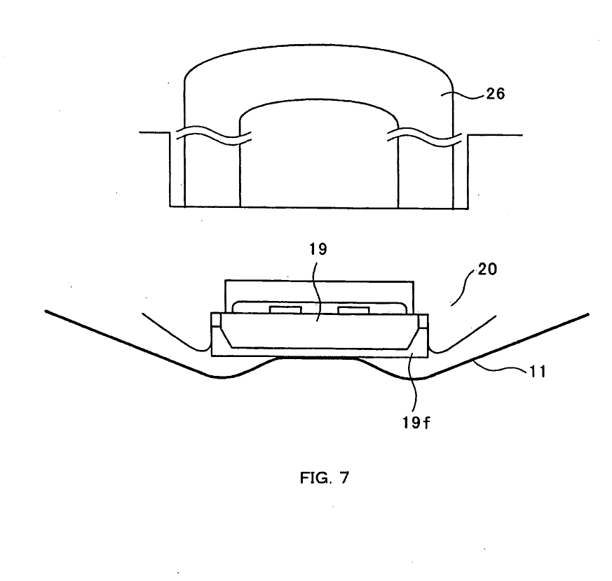

In the related art, the ridge of such laser scribing portion also is covered with the protecting layer 19f, as shown in FIG. 7, thereby preventing any inconvenience of the slide on the fixing film. However, such countermeasures increase a cost. Incidentally, the constituent members in FIG. 7 similar to those in the present embodiment are designated by the same reference numerals for the sake of convenience of explanation.

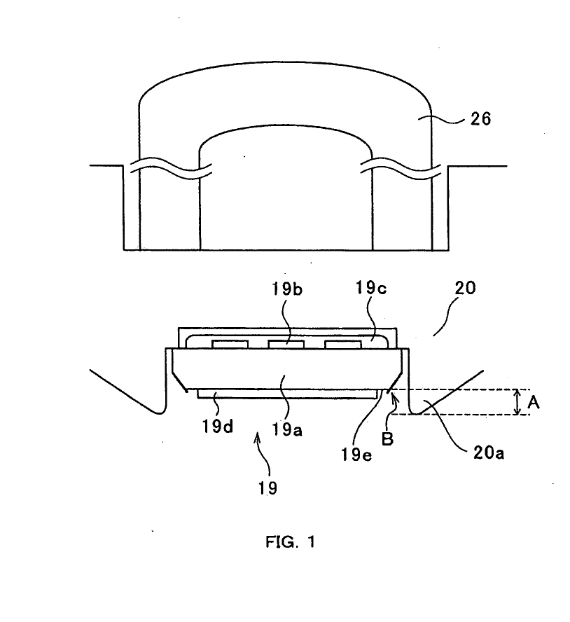

In contrast, in the present embodiment, as shown in FIG. 1, the ridge of the split line of the laser scribing portion (the split line or the laser scribing trace B) is not covered with the protecting layer, unlike in the related art, but a projection 20a projecting with respect to the ridge of the split line of the heater is formed at the heater holder 20. Moreover, in the present embodiment, the projection 20a projects toward the pressure roller with respect to a surface 19e, at which the slide layer 19d is formed, in the ceramic substrate 19a.

Consequently, it is possible to prevent any slide (i.e., any contact) between the fixing film 11 and the ridge of the split line of the heater. Therefore, it is possible to prevent any abrasion, any shave, or the like of the fixing film at the ridge of the split line of the heater, thus providing the fixing device in which a long lifetime can be achieved. In addition, it is unnecessary to dispose any protecting layer at the ridge of the split line of the heater, thus providing the fixing device at a reduced cost.

The projection amount A of the projection 20a from the surface 19e, at which the slide layer 19d is formed, should be desirably about 0.05 mm or more and about 0.5 mm or less. When the fixing film having a thin metallic layer as a base is used, the deformation of the fixing film becomes large if the projection amount is too large, thereby inducing cracks of the fixing film so as to shorten the lifetime of the fixing device. Therefore, the projection amount A of the heater holder should be desirably about 0.5 mm or less. In contrast, if the projection amount is too small, the fixing film accidentally slides on the projection, burr or the like at the ridge of the split line of the heater. Therefore, the projection amount A of the heater holder should be desirably about 0.05 mm or more.

In the present embodiment, the passing endurance test of A4-size sheets by laterally conveying was carried out in the fixing device in which the projection amount A of the heater holder is about 0.4 mm to 0.5 mm. As a result, the long lifetime of about 200,000 sheets could have been achieved without any occurrence of inconvenience such as cracks of the fixing film or cracks of the heater.

Although the description has been given of the color image forming apparatus as the image forming apparatus in the present embodiment, the present invention is not limited to this. The present invention may be applied to a monochromatic image forming apparatus.

### Second Embodiment

Next, a description will be given below of a second embodiment according to the present invention.

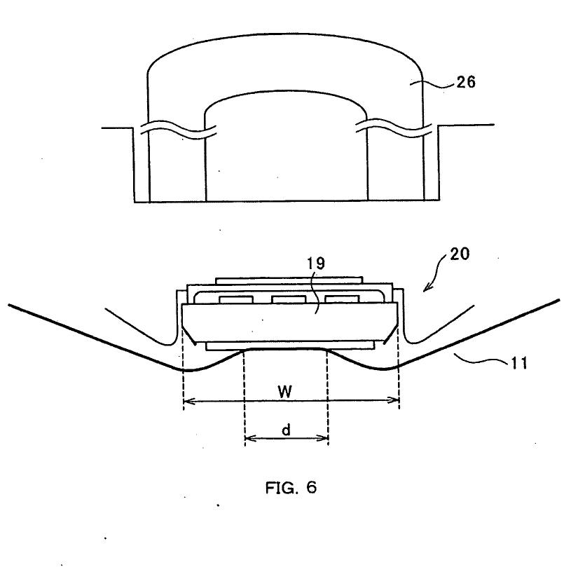

FIG. 6 is a cross-sectional view schematically showing essential parts in the surroundings of a heater in a fixing device in the present embodiment. In the present embodiment, a description will be given below of only constituent features different from those in the first embodiment, and therefore, the description of the same constituent features as those in the first embodiment will not be described.

The present embodiment is featured in that a part of a heater holder 20 does not project, unlike in the first embodiment, but that the relationship of a slide width between a fixing film 11 and a heater 19 is properly established, thus preventing any slide between the fixing film 11 and a ridge of a split line of the heater 19.

Assuming that W (mm) represents a width of the heater 19 in a recording material conveying direction and d (mm) represents a width of a slide portion between the heater 19 and the fixing film 11 in the recording material conveying direction, the values W and d are varied. The result of the variations of d/W will be shown below in Table 2.

TABLE 2

| | d/W | | | | | | |
|---|---|---|---|---|---|---|---|
| | 0.1 | 0.3 | 0.4 | 0.5 | 0.6 | 0.7 | 0.9 |
| LIFETIME | X | Δ | ◯ | ◯ | ◯ | Δ | X |
| OF | NG SINCE | FIXING | NO | NO | NO | NG DUE | NG SINCE |
| FIXING | HEATER | FILM | PROBLEM | PROBLEM | PROBLEM | TO | FIXING |
| DEVICE | PROTECTING | SLIPS | IN | IN | IN | TORQUE | FILM |
| | LAYER | DUE TO | 200000 | 200000 | 200000 | UP OF | CRACKS |
| | CRACKS | TORQUE | SHEETS | SHEETS | SHEETS | FIXING | IN 50000 |
| | IN ABOUT | UP OF | | | | DEVICE | SHEETS |
| | 70000 | FIXING | | | | CAUSED | |
| | SHEETS | DEVICE | | | | BY CRACK | |
| | | CAUSED | | | | OF | |
| | | BY CRACK | | | | FIXING | |
| | | OF | | | | FILM IN | |
| | | HEATER | | | | ABOUT | |
| | | PROTECTING | | | | 160000 | |
| | | LAYER | | | | SHEETS | |
| | | IN ABOUT | | | | | |
| | | 170000 | | | | | |
| | | SHEETS | | | | | |

The width d mm of a slide portion between the heater and the fixing film 11 is varied by varying the rigidity and pressurized force of the fixing film 11. Here, the rigidity of the fixing film 11 is varied by varying the thickness, material, diameter and the like of a base layer of the fixing film 11.

When the value d/W is about 1, the rotational trace of the fixing film 11 approaches a ridge of a split line of the heater, thereby raising an inconvenience due to the slide on a raised portion or the like in the vicinity of a laser scribing portion between the fixing film 11 and the heater 19. Here, the inconvenience liable to occur includes torque up due to shave or chips of the fixing film.

In contrast, when the value d/W is small, the efficiency of thermal conduction from the heater 19 to the fixing film 11 is degraded or the contact area between the heater 19 and the fixing film 11 becomes small. As a consequence, a pressure at a contact portion becomes high, thereby raising an inconvenience of occurrence of shave of a slide layer at the surface of the heater.

As a result of a study by the inventors of the present application, good results can be obtained if 0.3≦d/W≦0.7. The value d/W should desirably satisfy 0.4≦d/W≦0.6.

The present embodiment can produce the same effect as that in the above-described first embodiment.

Furthermore, there is no slide between the fixing film 11 and the heater holder 20 in the present embodiment, thus producing an effect that the shave of the fixing film can become smaller.

This application claims priority from Japanese Patent Application No. 2008-147180 filed Jun. 4, 2008, which hereby incorporated by reference herein.

What is claimed is:

1. An image heating apparatus for heating a recording material carrying an image thereon, the image heating apparatus comprising:
an endless belt having a metallic base layer;
a ceramic heater in contact with an inner surface of the endless belt, the ceramic heater including a substrate made of alumina and a heat generation resistor provided on the substrate;
a holder which holds the ceramic heater; and
a pressure roller which forms a nip portion at which the recording material carrying the image thereon is held and conveyed together with the ceramic heater via the endless belt,
wherein the heat generation resistor is disposed at a surface reverse to a surface facing the inner surface of the endless belt on the substrate,
wherein the substrate is one of a plurality of substrates which are divided from a large substrate along breaks formed on the large substrate, and a surface of the ceramic heater, which is on a side where the breaks are formed, is brought into contact with the inner surface of the endless belt, and
wherein the holder has a projection for guiding the endless belt in such a manner that the endless belt cannot be brought into contact with the break of the substrate.

2. An image heating apparatus for heating a recording material carrying an image thereon, the image heating apparatus comprising:
an endless belt having a metallic base layer;
a ceramic heater in contact with an inner surface of the endless belt, the ceramic heater including a substrate made of alumina and a heat generation resistor provided on the substrate;
a holder which holds the ceramic heater; and
a pressure roller which forms a nip portion at which the recording material carrying the image thereon is held and conveyed together with the ceramic heater via the endless belt,
wherein the heat generation resistor is disposed at a surface reverse to a surface facing the inner surface of the endless belt on the substrate,
wherein the substrate is one of a plurality of substrates which are divided from a large substrate along breaks formed on the large substrate, and a surface of the ceramic heater, which is on a side where the breaks are formed, is brought into contact with the inner surface of the endless belt, and
wherein the following expression is satisfied:
0.3≦d/W≦0.7
assuming that W (mm) represents a width of the ceramic heater in a recording material conveying direction and d (mm) represents a width of a slide region between the endless belt and the ceramic heater.
